(19) United States
(12) Patent Application Publication
(10) Pub. No.: US 2019/0106913 A1
(43) Pub. Date: Apr. 11, 2019

(54) CABLE FOR VEHICLE DOOR

(71) Applicant: AISIN SEIKI KABUSHIKI KAISHA, Kariya-shi (JP)

(72) Inventors: Satoshi FUKUCHI, Kariya-shi (JP); Takashi NISHIO, Kariya-shi (JP)

(73) Assignee: AISIN SEIKI KABUSHIKI KAISHA, Kariya-shi (JP)

(21) Appl. No.: 16/151,418

(22) Filed: Oct. 4, 2018

(30) Foreign Application Priority Data
Oct. 5, 2017 (JP) 2017-195088

(51) Int. Cl. E05B 79/20; E05B 79/22; E05B 77/22

(52) U.S. Cl. CPC E05B 79/20; E05B 77/22; E05B 79/22

(57) ABSTRACT

A cable for a vehicle door includes: a locking knob movable in a vertical direction between an unlocking position where the locking knob advances from an inside of the vehicle door to an inside of a vehicle interior and a locking position where the locking knob retreats from the inside of the vehicle interior to the inside of the vehicle door; a conduit having one end fixed to the vehicle door or a fixing member provided on the vehicle door, and the other end fixed to a door locking device capable of switching the vehicle door to the unlocked state or the locked state, and including an insertion hole formed to penetrate from the one end to the other end; and a core wire slidably inserted into the insertion hole and connect the locking knob and a locking/unlocking lever.

### CROSS REFERENCE TO RELATED APPLICATIONS

This application is based on and claims priority under 35 U.S.C. § 119 to Japanese Patent Application 2017-195088, filed on Oct. 5, 2017, the entire contents of which are incorporated herein by reference.

### TECHNICAL FIELD

This disclosure relates to a cable for a vehicle door.

### BACKGROUND DISCUSSION

JP 2009-275371A (Reference 1) discloses a door for an automobile including a locking knob that performs an operation of locking/unlocking the door and protrudes from the inside of the door to a vehicle interior through a mounting hole provided in a door trim, a conduit that has one end fixed to a holding part provided on the door trim and the other end fixed to a door latch device for locking/unlocking the door, and an inner cable that is slidably inserted into the conduit and has one end connected to the locking knob and the other end connected to a locking/unlocking lever of the door latch device.

In the door for an automobile disclosed in Reference 1, the inner cable slides in the conduit in accordance with an operation of the locking knob and transmits the operating force to the locking/unlocking lever of the door latch device.

However, in the door for an automobile, there is a likelihood that foreign matters such as liquids or dust may intrude into the door from the vehicle interior through the mounting hole provided in the door trim. In this way, the sliding movement of the inner cable may be obstructed by the intrusion of the foreign matters into the conduit.

Thus, a need exists for a cable for a vehicle door which is not susceptible to the drawback mentioned above.

### SUMMARY

A cable for a vehicle door according to an aspect of this disclosure includes: a locking knob configured to be movable in a vertical direction of a vehicle between an unlocking position at which the locking knob advances from an inside of the vehicle door to an inside of a vehicle interior through an opening provided at a portion of the vehicle door inside the vehicle interior and a locking position at which the locking knob retreats from the inside of the vehicle interior to the inside of the vehicle door with respect to the unlocking position, corresponding to an unlocked state and a locked state of the vehicle door; a conduit having one end fixed to the vehicle door or a fixing member provided on the vehicle door in the vicinity of the opening, and the other end fixed to a door locking device capable of switching the vehicle door to the unlocked state or the locked state, and including an insertion hole formed to penetrate from the one end to the other end; and a core wire configured to be slidably inserted into the insertion hole of the conduit and connect the locking knob and a locking/unlocking lever of the door locking device that moves to a predetermined position in accordance with the locked state and the unlocked state, in which the locking knob includes a cover unit configured to cover an end at the one end side of the insertion hole of the conduit in a direction orthogonal to the vertical direction of the vehicle, and the cover unit has a lower end in the vertical direction of the vehicle which is positioned below an upper end of the insertion hole at least when the locking knob is positioned at the locking position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a vehicle door according to an embodiment disclosed here;

FIG. 2 is a cross-sectional view of the vehicle door according to the embodiment taken along arrow line II-II;

FIG. 3 is a partially enlarged view of the vehicle door according to the embodiment;

FIG. 4 is an exploded perspective view of the cable for a vehicle door according to the embodiment;

FIG. 5A is a view illustrating the cable for a vehicle door according to the embodiment in which a locking knob is positioned at an unlocking position, and FIG. 5B is a view illustrating the cable for a vehicle door according to the embodiment in which the locking knob is positioned at a locking position;

FIG. 6A is a view illustrating a state where a main body unit and a cover unit according to the embodiment engage with each other, and FIG. 6B is a view illustrating a state where the main body unit, the cover unit, and an operation unit according to the embodiment engage with one another;

FIG. 7 is a cross-sectional view of the cable for a vehicle door according to the embodiment taken along arrow line VII-VII; and

FIG. 8A is a view illustrating a cable for a vehicle door according to a comparative example, and FIG. 8B is a view illustrating the cable for a vehicle door according to the embodiment disclosed here.

### DETAILED DESCRIPTION

Hereinafter, an embodiment of a cable for a vehicle door disclosed here (hereinafter, simply referred to as a door cable) will be described.

In the following description, an upward and downward direction of a vehicle is defined as a vertical direction Z. In addition, an upward direction of the vertical direction Z of the vehicle is defined as an upward direction Z1, and a downward direction of the vehicle is defined as a downward direction Z2.

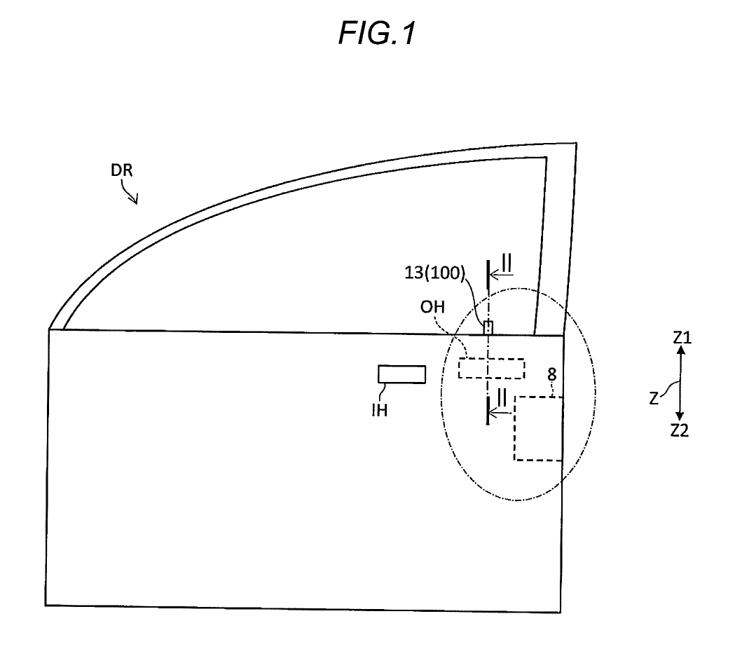

FIG. 1 is a side view illustrating a vehicle door DR disposed at a right front side of the vehicle when viewed from the inside of a vehicle interior to the outside of the vehicle interior. As illustrated in FIG. 1, on the vehicle door DR, an inside handle IH is disposed to be exposed to the inside of the vehicle interior, and an outside handle OH is disposed to be exposed to the outside of the vehicle interior. Further, the vehicle door DR is configured such that an entrance (not illustrated) formed in a vehicle main body is openable/closable when the inside handle IH or the outside handle OH is operated by a user of the vehicle.

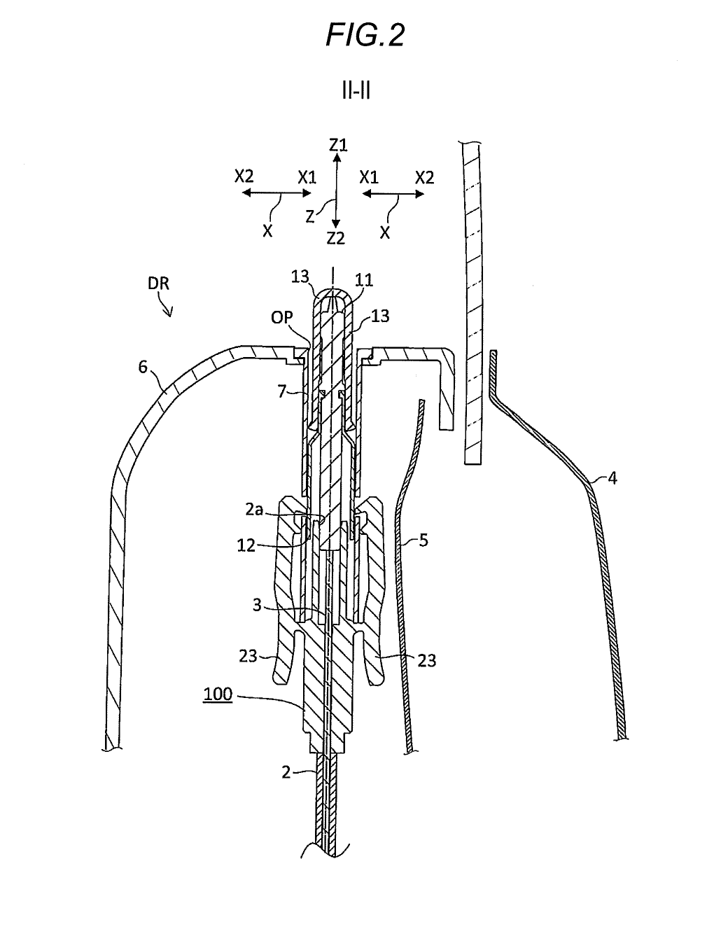

FIG. 2 is a cross-sectional view of the vehicle door DR illustrated in FIG. 1 taken along arrow line II-II. As illustrated in FIG. 2, the vehicle door DR has an outer panel 4 outside the vehicle interior and an inner panel 5 inside the vehicle interior each of which is fabricated by performing press-processing on a steel plate, a door trim 6 which is made of resin and mounted on the inner panel 5 from the inside of the vehicle, and a bezel 7 which is mounted on an upper surface of the door trim 6 and serves as a “fixing member.” In the present embodiment, an outer periphery of the vehicle door DR is defined by the outer panel 4 and the door trim 6. That is, the inside of the outer periphery of the vehicle door DR, which is defined by the outer panel 4 and the door trim 6, is the inside of the vehicle door DR.

The bezel 7 has an opening OP formed to penetrate therethrough in the vertical direction Z. Further, the inside of the vehicle door DR and the inside of the vehicle interior, which is defined by the outer periphery of the vehicle door DR, are in communication with each other through the opening OP.

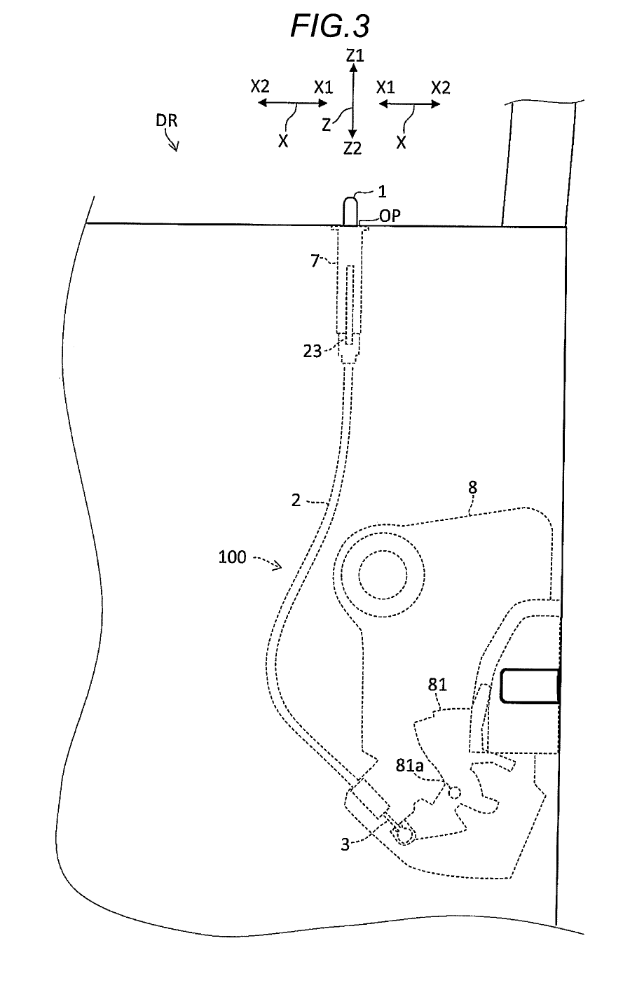

FIG. 3 is a partially enlarged view of the vehicle door DR illustrated in FIG. 1. As illustrated in FIG. 3, the vehicle door DR further has a door locking device 8 configured to maintain a closed state of the vehicle door DR, and a door cable 100 configured to transmit an operating force of the user to the door locking device 8.

The door locking device 8 may switch between an unlocked state where the vehicle door DR may be opened by the operation of the inside handle IH or the outside handle OH and a locked state where the vehicle door DR cannot be opened. In detail, a locking/unlocking lever 81 of the door locking device 8 rotates (moves) about a rotating shaft 81a to a predetermined position, so that the vehicle door DR switches to the unlocked state or the locked state.

The door cable 100 has a locking knob 1 which advances and retreats from the inside of the vehicle door DR into the vehicle interior through the opening OP of the bezel 7, a conduit 2 made of resin, which has one end fixed to the bezel 7 and the other end fixed to the door locking device 8, and a core wire 3 made of metal, which is inserted into the conduit 2 and connects the locking knob 1 and the locking/unlocking lever 81 of the door locking device 8.

When the vehicle door DR is in the unlocked state, the locking knob 1 of the door cable 100 is positioned at the unlocking position (position illustrated in FIG. 3) at which the locking knob 1 advances from the inside of the vehicle door DR to the inside of the vehicle interior in the upward direction Z1. In this state, when the user of the vehicle pushes the locking knob 1 in the downward direction Z2, the locking knob 1 is moved to the locking position at which the locking knob 1 retreats from the inside of the vehicle interior to the inside of the vehicle door DR in the downward direction Z2 with respect to the unlocking position. Then, the core wire 3, which connects the locking knob 1 and the locking/unlocking lever 81, slides inside the conduit 2 and transmits the operating force to the locking/unlocking lever 81. In this way, as the locking/unlocking lever 81 rotates (moves), the vehicle door DR switches from the unlocked state to the locked state.

In the present embodiment, the locking knob 1 is set to be approximately flush with an upper surface of the bezel 7 at the locking position. The configuration is for preventing a third party from making the vehicle door DR in the unlocked state, for example, by breaking window glass and then operating the locking knob 1 from the outside of the vehicle interior after the user makes the vehicle door DR in the locked state and then leaves the vehicle. Therefore, an anti-theft property of the vehicle is improved. Meanwhile, in a normal mode, in a case where the user in the vehicle interior intends to switch from the locked state of the vehicle door DR to the unlocked state, the user may switch from the locked state of the vehicle door DR to the unlocked state by operating the inside handle IH once. Further, after the vehicle door DR is switched to the unlocked state, the user may open the vehicle door DR by operating the inside handle IH again.

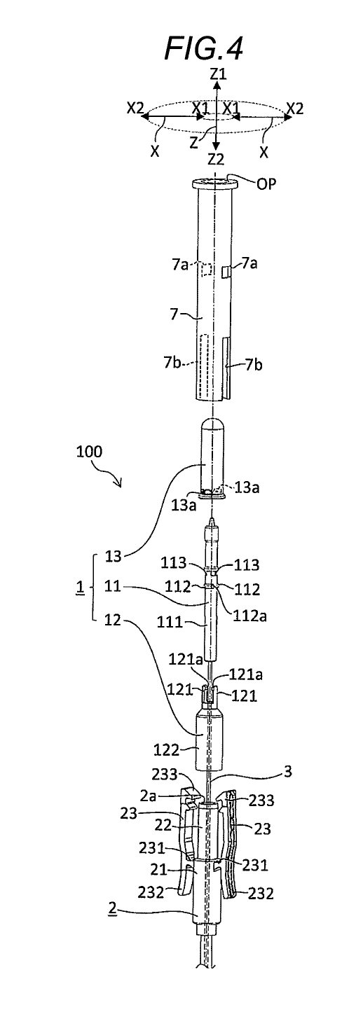

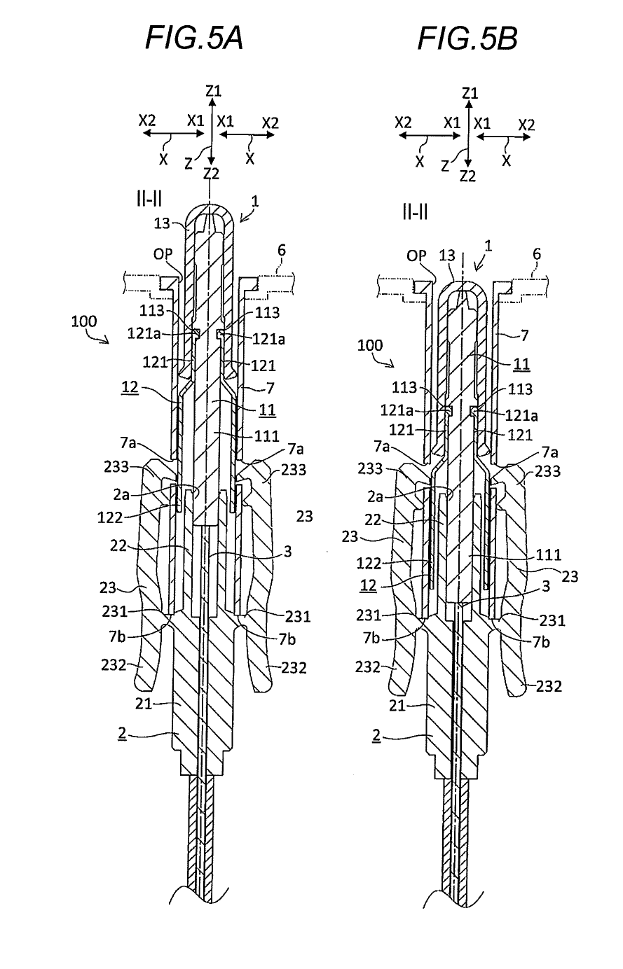

Next, the configurations of the bezel 7 and the door cable 100 of the present embodiment will be further described in detail by noting one end side of the door cable 100 with reference to an exploded perspective view of the bezel 7 and the door cable 100 illustrated in FIG. 4 and a cross-sectional view of the vehicle door DR taken along line II-II illustrated in FIGS. 5A and 5B. Further, in FIGS. 5A and 5B, FIG. 5A illustrates the door cable 100 when the locking knob 1 is positioned at the unlocking position, and FIG. 5B illustrates the door cable 100 when the locking knob 1 is positioned at the locking position.

In the following description, a direction orthogonal to a direction that runs through a central axis of the locking knob 1 in the direction (vertical direction Z) in which the locking knob 1 advances and retreats is defined as a radial direction X. In addition, a direction in the radial direction X, which is directed toward the central axis of the locking knob 1, is defined as a first direction X1, and a direction in the radial direction X, which is directed away from the central axis of the locking knob 1, is defined as a second direction X2.

As illustrated in FIG. 4, the bezel 7 has an approximately cylindrical shape such that the opening OP is formed at the center in the radial direction X of an approximately columnar shape to penetrate in the vertical direction Z. In addition, engaging holes 7a are formed in the bezel 7 at the center in the vertical direction Z, and notches 7b are formed at a lower end of the bezel 7 at both sides in the radial direction X.

As described above, the door cable 100 has the conduit 2, the locking knob 1, and the core wire 3.

As illustrated in FIGS. 5A and 5B, an insertion hole 2a, into which the core wire 3 is inserted, penetrates through the conduit 2. The insertion hole 2a is formed from one end to the other end of the conduit 2. In addition, the conduit 2 has a pair of engaging pawls 23 which is formed at one end of the conduit 2 to engage with the bezel 7, a first cylindrical portion 21 which is a base end of the engaging pawl 23 and has a cylindrical shape, and a second cylindrical portion 22 which has a cylindrical shape and extends from the first cylindrical portion 21 to a tip at one end side.

Each of the pair of engaging pawls 23 has a support portion 231 which extends from the first cylindrical portion 21 in the second direction X2, a grip portion 232 which extends from the tip of the support portion 231 in the downward direction Z2, and an engaging portion 233 which extends from the tip of the support portion 231 in the upward direction Z1. In a case where an operator intends to fix one end of the conduit 2 with respect to the bezel 7, the operator holds the grip portion 232 first, so that the engaging portion 233 is elastically deformed in the second direction X2 based on the support portion 231 as a support point. Next, in a state where the elastic deformation of the engaging portion 233 is maintained, the door cable 100 (locking knob 1) is inserted from the downward direction Z2 to the upward direction Z1 with respect to the bezel 7 at a position at which the support portion 231 and the notch 7b of the bezel 7 correspond to each other. Further, when the elastic deformation of the engaging portion 233 is released at the position at which the engaging hole 7a of the bezel 7 and the tip of the engaging portion 233 correspond to each other, the tip of the engaging portion 233 engages with the engaging hole 7a of the bezel 7. In this way, one end of the conduit 2 is fixed with reference to the bezel 7.

An outer diameter of the second cylindrical portion 22 is set to be smaller than an outer diameter of the first cylindrical portion 21. In addition, among the insertion holes 2a formed in the conduit 2, a diameter of the insertion hole 2a formed in the second cylindrical portion 22 is set to be larger than a diameter of the insertion hole 2a formed in a portion other than the second cylindrical portion 22 of the conduit 2.

As illustrated in FIG. 4, the locking knob 1 has a main body unit 11 which is fixed to one end of the core wire 3, and a cover unit 12 and an operation unit 13 which are mounted on the main body unit 11.

The main body unit 11 is fabricated by performing insert-molding on the core wire 3, which is fabricated in advance, with a resin material. The main body unit 11 has a columnar portion 111 which extends in the vertical direction Z as an axis, two mounting portions 112 which are formed at the center in the vertical direction Z of the columnar portion 111 and protrude in the second direction X2 at both sides in the radial direction X, and two concave portions 113 which are formed at portions above the mounting portions 112 in the upward direction Z1 and recessed at both sides in the radial direction X in a direction in the first direction X1 which intersects the direction in which the mounting portions 112 protrude. In addition, a restricting portion 112a, which extends in a circumferential direction of the columnar portion 111, is formed on one of the two mounting portions 112.

As illustrated in FIGS. 5A and 5B, an outer diameter of the columnar portion 111 is set to be slightly smaller than an inner diameter of the second cylindrical portion 22 of the conduit 2. For this reason, when the locking knob 1 moves in the vertical direction Z, the columnar portion 111 slides along an inner surface of the second cylindrical portion 22 in a state where the columnar portion 111 is accommodated in the second cylindrical portion 22.

As illustrated in FIG. 4, the operation unit 13 has a cap shape as an approximately hemispherical shape is connected to an upper surface having an approximately cylindrical shape. Mounting holes 13a are formed at a lower end of the operation unit 13 at both sides in the radial direction X. Further, the operation unit 13 is fabricated by performing plating processing on a surface of relatively hard resin such as polycarbonate resin. In addition, the operation unit 13 is a design member which is partially exposed to the inside of the vehicle interior from the opening OP at least in the unlocked state.

The cover unit 12 has a pair of engaging pieces 121 which extends in the vertical direction Z, and a cylindrical cover piece 122 which extends in the downward direction Z2 from the lower end of the engaging piece 121.

A convex portion 121a, which extends in the first direction X1, is formed at an upper end of each of the engaging pieces 121. In addition, a distance, which connects tips of the convex portions 121a, is set to be shorter than a diameter of the columnar portion 111 of the main body unit 11.

As illustrated in FIGS. 5A and 5B, an inner diameter of the cover piece 122 is set to be larger than an outer diameter of the first cylindrical portion 21. For this reason, the cover piece 122 (cover unit 12) is configured to cover, from the second direction X2, an end at one end side of the insertion hole 2a of the second cylindrical portion 22 (conduit 2). In addition, a length of the cover piece 122, which extends in the downward direction Z2, is set such that a lower end of the cover piece 122 is positioned below an upper end of the insertion hole 2a formed in the second cylindrical portion 22 (conduit 2) even in a case where the locking knob 1 illustrated in FIG. 5A is positioned at the unlocking position shifted in the upward direction Z1 with respect to the locking position as well as a case where the locking knob 1 illustrated in FIG. 5B is positioned at the locking position.

The cover unit 12 is made of a resin material (polyvinylchloride resin, etc.) which is softer than a resin material that constitutes the operation unit 13.

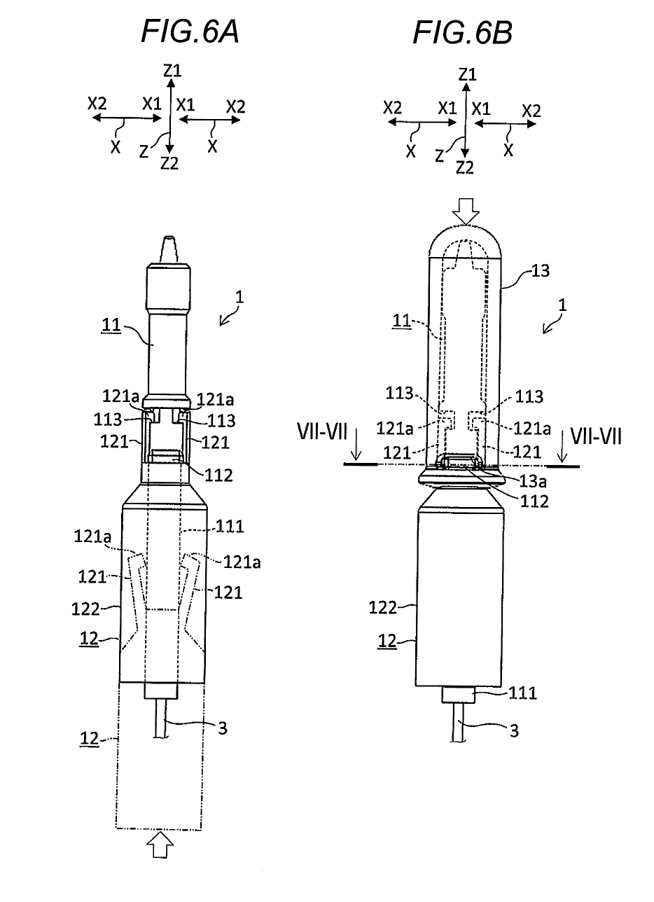

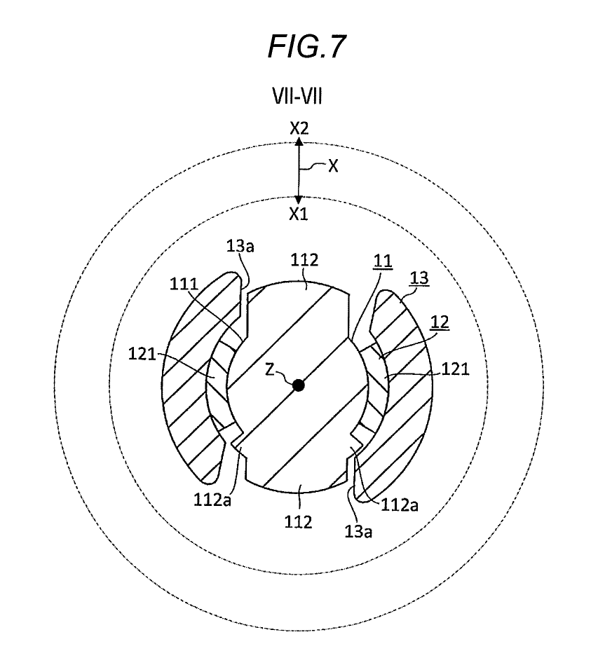

Here, a process of integrating the main body unit 11, the cover unit 12, and the operation unit 13, which constitute the locking knob 1, will be described with reference to FIGS. 6A, 6B, and 7.

As illustrated in FIG. 6A, the cover unit 12 is moved from the downward direction Z2 to the upward direction Z1 (indicated by the alternate long and two short dashes line) with respect to the main body unit 11 first in order to integrate the locking knob 1. Then, the engaging pieces 121 of the cover unit 12, which have the distance set to be shorter than the diameter of the columnar portion 111 of the main body unit 11, are elastically deformed in the second direction X2. Further, when the cover unit 12 is further moved in the upward direction Z1, the convex portions 121a of the engaging pieces 121 are fitted with the concave portions 113 of the main body unit 11 in the first direction X1 at the portions where the convex portions 121a reach the concave portions 113. In this way, the cover unit 12 and the main body unit 11 engage with each other.

After the cover unit 12 is attached to the main body unit 11, the operation unit 13 covers the main body unit 11 from the upward direction Z1 to the downward direction Z2, as illustrated in FIG. 6B. Then, the mounting portions 112 of the main body unit 11 are fitted with the mounting holes 13a of the operation unit 13. In this way, the operation unit 13 is mounted on the main body unit 11.

As illustrated in FIG. 7, in the state where the operation unit 13 is mounted on the main body unit 11, the operation unit 13 covers, from the second direction X2, the engaging pieces 121 of the cover unit 12 which engages with the main body unit 11 from the second direction X2. In addition, in the state where the main body unit 11 and the cover unit 12 engage with each other, the restricting portions 112a formed on the mounting portions 112 of the main body unit 11 face the engaging pieces 121 of the cover unit 12 in the circumferential direction defined about the vertical direction Z.

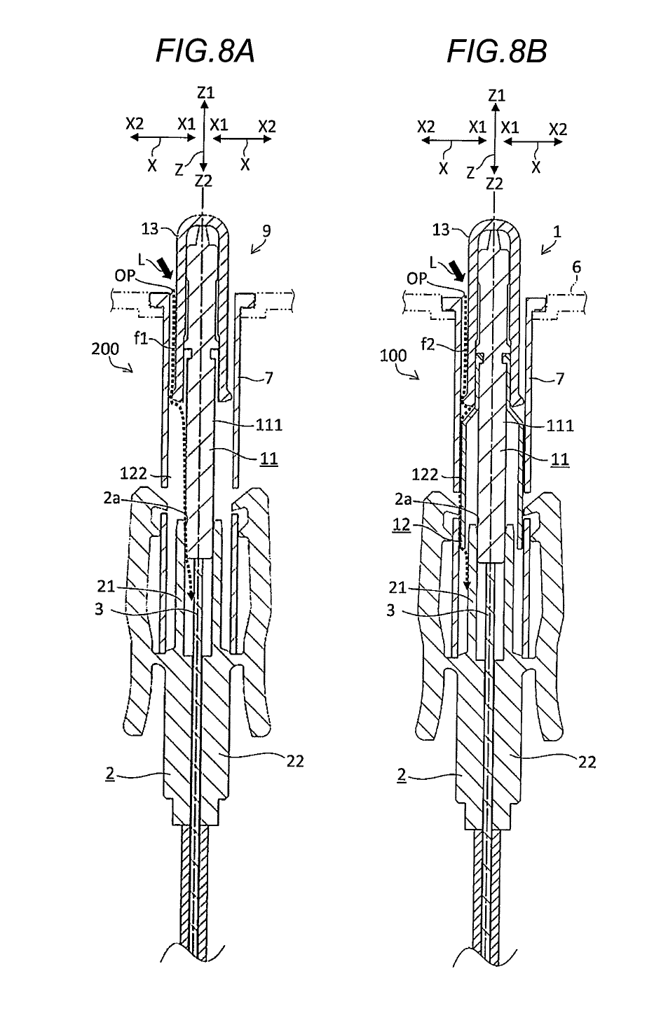

Next, an operation of the door cable 100 of the present embodiment will be described with reference to FIGS. 2, 8A, and 8B.

As described above with reference to FIG. 2, the vehicle door DR has the opening OP that allows the inside of the vehicle interior and the inside of the vehicle door DR to be in communication with each other. For this reason, it is conceivable that foreign matters intrude into the vehicle door DR from the inside of the vehicle interior through the opening OP. As an example, there is concern that dust floating in the air may intrude into the vehicle door DR. In addition, there is also concern that a liquid may intrude into the vehicle door DR in a situation such as when a user may spill a drink or rain water may be driven into the vehicle interior in a state where the window glass is opened. According to the door cable 100 of the present embodiment, it is possible to suppress foreign matters, which intrude into the vehicle door DR as described above, from intruding into the insertion hole 2a of the conduit 2. Hereinafter, the operation will be described with reference to an example in which a liquid intrudes into the vehicle door DR through the opening OP and with reference to FIGS. 8A and 8B in comparison with a comparative example.

First, a door cable 200 of the comparative example will be described with reference to FIG. 8A. FIG. 8A is a view illustrating the door cable 200 of the comparative example when the locking knob 9 is positioned at the unlocking position. The door cable 200 of the comparative example differs from the door cable 100 of the present embodiment in that no cover unit 12 is provided on the locking knob 9. Further, the same reference numerals denote the configurations of the door cable 200 of the comparative example which are identical to the configurations of the door cable 100 of the present embodiment.

As illustrated in FIG. 8A, it is assumed that a liquid L intrudes into the vehicle door DR through the opening OP provided in the bezel 7. Then, a part of the liquid L intruding into the vehicle door DR flows in the downward direction Z2 along the locking knob 9 by gravity (flow path f1). Further, the liquid L further intrudes into the insertion hole 2a of the conduit 2 along the core wire 3 fixed to the locking knob 9 from the locking knob 9 (main body unit 11).

Next, the door cable 100 of the present embodiment will be described with reference to FIG. 8B. FIG. 8B is a view illustrating the door cable 100 of the present embodiment when the locking knob 1 is positioned at the unlocking position.

As illustrated in FIG. 8B, it is assumed that the liquid L intrudes into the vehicle door DR through the opening OP provided in the bezel 7. Then, similar to the comparative example, a part of the liquid L intruding into the vehicle door DR flows in the downward direction Z2 along the locking knob 1 by gravity (flow path f2). Further, the liquid L flows along the flow path f2 and reaches the cover unit 12 along the operation unit 13. Here, the cover unit 12 covers, from the second direction X2, the end at one end side of the insertion hole 2a of the conduit 2 (second cylindrical portion 22). For this reason, the liquid L, which flows along the cover unit 12, flows in the downward direction Z2 at the outside (second direction X2 side) of the end at the one end side of the insertion hole 2a. Further, the liquid L further flows in the downward direction Z2, and the liquid L reaches the lower end of the cover unit 12. Here, the lower end of the cover unit 12 is positioned below the upper end of the insertion hole 2a of the conduit 2 (second cylindrical portion 22) even in the case where the locking knob 1 is positioned at the unlocking position at which the locking knob 1 is positioned in the upward direction Z1 with respect to the locking position. For this reason, the liquid L, which reaches the lower end of the cover unit 12, further flows from the lower end of the cover unit 12 in the downward direction Z2 without intruding into the insertion hole 2a while overcoming gravity.

In this way, in comparison with the door cable 200 of the comparative example, the door cable 100 of the present embodiment, which has the cover unit 12, may suppress the liquid, which has intruded into the vehicle door DR, from intruding into the insertion hole 2a.

The operation of the door cable 100 of the present embodiment has been described above with reference to the liquid, as an example, which intrudes into the vehicle door DR, but according to the cover unit 12 of the present embodiment, it is possible to suppress even solid foreign matters such as dust from intruding into the insertion hole 2a.

The operation of the door cable 100 of the present embodiment is of course effective even in a case where the locking knob 1 is positioned at the locking position shifted in the downward direction Z2 with respect to the unlocking position.

As described above, the door cable 100 of the present embodiment may exhibit the following effects.

Since the cover unit 12 is provided on the locking knob 1, foreign matters are suppressed from intruding into the insertion hole 2a of the conduit 2. Therefore, while the core wire 3 slides in the conduit 2, obstruction hardly occurs on the core wire 3, such as a situation in which solids such as dust intruding into the insertion hole 2a are deposited in a gap between the insertion hole 2a and the core wire 3 or a situation in which the liquid intruding into the insertion hole 2a is frozen. As a result, it is possible to suppress impairment of operating characteristics when the user operates the locking knob 1.

The length of the cover unit 12, which extends in the downward direction Z2, is set such that the lower end of the cover unit 12 is positioned below the upper end of the insertion hole 2a even in the case where the locking knob 1 is positioned at the unlocking position shifted in the upward direction Z1 from the locking position. Therefore, it is possible to suppress foreign matters from intruding into the insertion hole 2a regardless of whether the locking knob 1 is positioned at the locking position or the unlocking position.

As a resin material that constitutes the cover unit 12, a material, which is softer than the resin material that constitutes the operation unit 13, is selected. Therefore, it is possible to improve formability of the cover unit 12 with respect to the operation unit 13.

Since the cover unit 12 is manufactured as a body separate from the operation unit 13 which is a design member, it is not necessary to fabricate and manage the cover unit 12 as the design member. Therefore, it is possible to improve productivity of the cover unit 12.

As described with reference to FIG. 7, the cover unit 12 engages with the main body unit 11 in the second direction X2, and then the operation unit 13 is mounted on the main body unit 11 so as to cover the cover unit 12 from the second direction X2. Therefore, it is possible to allow the main body unit 11 and the cover unit 12 to more rigidly engage with each other.

Similarly, as described with reference to FIG. 7, in the state where the cover unit 12 is mounted on the main body unit 11, the restricting portion 112a, which extends from the mounting portion 112 of the main body unit 11 in the circumferential direction of the columnar portion 111, extends to face the cover unit 12 in the circumferential direction based on the vertical direction Z. Therefore, the rotation of the cover unit 12 in the circumferential direction based on the vertical direction Z is restricted. As a result, the cover unit 12 may more stably engage with the main body unit 11.

The door cable 100 of the present embodiment may be changed as described below.

The length of the cover unit 12, which extends in the downward direction Z2, may be set such that the lower end of the cover unit 12 is positioned below the upper end of the insertion hole 2a in the case where the locking knob 1 is positioned at least at the locking position. That is, the lower end of the cover unit 12 may be positioned above the upper end of the insertion hole 2a in the case where the locking knob 1 is positioned at the unlocking position. Even in this configuration, it is possible to suppress foreign matters, which have intruded into the vehicle door DR, from intruding into the insertion hole 2a in the case where the locking knob 1 is positioned at the locking position.

A structure for integrating the cover unit 12 and the main body unit 11 and a structure for integrating the operation unit 13 and the main body unit 11 are not limited to the structure in the embodiment. That is, for example, the main body unit 11 and at least one of the cover unit 12 and the operation unit 13 may be fixed by an adhesive or fixed by a fastening member such as a bolt.

Any two or three of the main body unit 11, the cover unit 12, and the operation unit 13 may be integrally fabricated. Even in this case, since the cover unit 12 is provided on the locking knob 1, it is possible to suppress foreign matters, which have intruded into the vehicle door DR, from intruding into the insertion hole 2a.

The cover unit 12 and the operation unit 13 may be made of the same material. In addition, as a material that constitutes the cover unit 12, a material, which is harder than a material that constitutes the operation unit 13, may be selected.

The locking knob 1 may not be flush with the upper surface of the bezel 7 (vehicle door DR) in the locked state. That is, in the locked state, the locking knob 1 may advance from the upper surface of the bezel 7 to the inside of the vehicle interior or may retreat from the upper surface of the bezel 7 into the vehicle door DR.

The opening OP may be formed directly at the outer periphery of the vehicle door DR without providing the bezel 7 on the vehicle door DR.

A method of fixing one end of the conduit 2 to the vehicle door DR in the vicinity of the opening OP is not limited to the method in the embodiment. That is, for example, a fixing member for fixing one end of the conduit 2 to the door trim 6 or the inner panel 5 may protrude in the first direction X1.

A cable for a vehicle door according to an aspect of this disclosure includes: a locking knob configured to be movable in a vertical direction of a vehicle between an unlocking position at which the locking knob advances from an inside of the vehicle door to an inside of a vehicle interior through an opening provided at a portion of the vehicle door inside the vehicle interior and a locking position at which the locking knob retreats from the inside of the vehicle interior to the inside of the vehicle door with respect to the unlocking position, corresponding to an unlocked state and a locked state of the vehicle door; a conduit having one end fixed to the vehicle door or a fixing member provided on the vehicle door in the vicinity of the opening, and the other end fixed to a door locking device capable of switching the vehicle door to the unlocked state or the locked state, and including an insertion hole formed to penetrate from the one end to the other end; and a core wire configured to be slidably inserted into the insertion hole of the conduit and connect the locking knob and a locking/unlocking lever of the door locking device that moves to a predetermined position in accordance with the locked state and the unlocked state, in which the locking knob includes a cover unit configured to cover an end at the one end side of the insertion hole of the conduit in a direction orthogonal to the vertical direction of the vehicle, and the cover unit has a lower end in the vertical direction of the vehicle which is positioned below an upper end of the insertion hole at least when the locking knob is positioned at the locking position.

According to the configuration, when foreign matters intrude into the vehicle door from the inside of the vehicle interior through the opening provided in the vehicle door, the cover unit of the locking knob may suppress the foreign matters from intruding into the insertion hole of the conduit in the case where the locking knob is positioned at least at the locking position. That is, resistance of the cable for a vehicle door against the foreign matters intruding into the vehicle door is improved.

In the cable for a vehicle door, the lower end of the cover unit in the vertical direction of the vehicle may be positioned below the upper end of the insertion hole in the vertical direction of the vehicle when the locking knob is positioned at the locking position and the unlocking position.

According to the configuration, it is possible to suppress foreign matters from intruding into the insertion hole of the conduit regardless of whether the locking knob is positioned at the locking position or the unlocking position.

In the cable for a vehicle door, the locking knob may include an operation unit that is exposed to the inside of the vehicle interior at least at the unlocking position, the operation unit and the cover unit may be separate members, and the cover unit may be made of a material softer than a material of the operation unit.

According to the configuration, it is possible to improve formability of the cover unit with respect to the operation unit.

In the cable for a vehicle door, the locking knob may include a main body unit fixed to one end of the core wire and configured to engage with the cover unit and the operation unit, the cover unit may have an engaging piece configured to engage with the main body unit from a direction orthogonal to the vertical direction of the vehicle, and the operation unit may be mounted on the main body unit to cover the engaging piece in the direction orthogonal to the vertical direction of the vehicle.

According to the configuration, it is difficult for the operation unit to disengage the engaging piece of the cover unit. That is, the main body unit and the cover unit may rigidly engage with each other.

In the cable for a vehicle door, the main body unit may have a columnar portion that extends in the vertical direction of the vehicle as an axis, and the columnar portion may have a restricting portion which extends in a circumferential direction of the columnar portion to face the engaging piece.

According to the configuration, the rotation of the engaging piece in the circumferential direction of the columnar portion is restricted by the restricting portion. As a result, the cover unit may more stably engage with the main body unit.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A cable for a vehicle door, comprising:
a locking knob configured to be movable in a vertical direction of a vehicle between an unlocking position at which the locking knob advances from an inside of the vehicle door to an inside of a vehicle interior through an opening provided at a portion of the vehicle door inside the vehicle interior and a locking position at which the locking knob retreats from the inside of the vehicle interior to the inside of the vehicle door with respect to the unlocking position, corresponding to an unlocked state and a locked state of the vehicle door;
a conduit having one end fixed to the vehicle door or a fixing member provided on the vehicle door in the vicinity of the opening, and the other end fixed to a door locking device capable of switching the vehicle door to the unlocked state or the locked state, and including an insertion hole formed to penetrate from the one end to the other end; and
a core wire configured to be slidably inserted into the insertion hole of the conduit and connect the locking knob and a locking/unlocking lever of the door locking device that moves to a predetermined position in accordance with the locked state and the unlocked state,
wherein the locking knob includes a cover unit configured to cover an end at the one end side of the insertion hole of the conduit in a direction orthogonal to the vertical direction of the vehicle, and the cover unit has a lower end in the vertical direction of the vehicle which is positioned below an upper end of the insertion hole at least when the locking knob is positioned at the locking position.

2. The cable according to claim 1,
wherein the lower end of the cover unit in the vertical direction of the vehicle is positioned below the upper end of the insertion hole in the vertical direction of the vehicle when the locking knob is positioned at the locking position and the unlocking position.

3. The cable according to claim 1,
wherein the locking knob includes an operation unit that is exposed to the inside of the vehicle interior at least at the unlocking position,
the operation unit and the cover unit are separate members, and
the cover unit is made of a material softer than a material of the operation unit.

4. The cable according to claim 3,
wherein the locking knob includes a main body unit fixed to one end of the core wire and configured to engage with the cover unit and the operation unit,
the cover unit has an engaging piece configured to engage with the main body unit from a direction orthogonal to the vertical direction of the vehicle, and
the operation unit is mounted on the main body unit to cover the engaging piece in the direction orthogonal to the vertical direction of the vehicle.

5. The cable according to claim 4,
wherein the main body unit has a columnar portion that extends in the vertical direction of the vehicle as an axis, and
the columnar portion has a restricting portion that extends in a circumferential direction of the columnar portion to face the engaging piece.
